(19) United States
(12) Patent Application Publication
(10) Pub. No.: US 2017/0005346 A1
(43) Pub. Date: Jan. 5, 2017

(54) CHANNEL FRAME FOR FUEL CELLS

(71) Applicant: Hyundai Motor Company, Seoul (KR)

(72) Inventors: Soo Jin Lim, Seongnam (KR); Bo Ki Hong, Seoul (KR); Byeong-Heon Jeong, Seongnam (KR)

(21) Appl. No.: 14/954,089

(22) Filed: Nov. 30, 2015

(30) Foreign Application Priority Data
Jul. 1, 2015 (KR) 10-2015-0094244

(51) Int. Cl. H01M 8/02; H01M 8/10

(52) U.S. Cl. CPC H01M 8/0273; H01M 8/1004; H01M 2008/1095

(57) ABSTRACT

A channel frame for fuel cells is arranged for integrally assembling a membrane electrode assembly (MEA) having an electrolyte membrane, an anode electrode and a cathode electrode, with gas diffusion layers (GDLs) disposed on both surfaces of the membrane electrode assembly. The channel frame includes at least one protruding portion which protrudes toward an anode-side separator and a cathode-side separator and defines inlet or outlet channels for reaction gas on the channel frame.

### CROSS-REFERENCE TO RELATED APPLICATION

This application claims under 35 U.S.C. §119(a) the benefit of Korean Patent Application No. 10-2015-0094244, filed on Jul. 1, 2015, the entire contents of which are incorporated by reference herein.

### BACKGROUND

1. Field of the Invention

The present invention relates to a channel frame for fuel cells, and more particularly to a channel frame for fuel cells used to integrally assemble a membrane electrode assembly and gas diffusion layers, and which includes reaction gas channels.

2. Description of the Related Art

Recently, efforts have been made to develop technologies for exploiting various alternative energy sources because of the depletion of natural resources such as oil and increased environmental concerns.

A fuel cell is an electrical power generation device which directly converts chemical energy generated from a chemical reaction between hydrogen and oxygen into electrical energy. Basically, the reaction of the fuel cell is a reverse reaction of the electrolysis of water, which generates electricity as well as heat and water.

In order to convert the chemical energy created by the oxidation of fuel into electrical energy, the fuel cell includes a fuel electrode (anode), in which an oxidation reaction of hydrogen occurs, and an air electrode (cathode), in which a reduction reaction of oxygen occurs at the same time.

Different fuel cells utilize the same operating principle, but are classified based on various conditions including the kind of fuel that is used, the operating temperature, the catalyst, the electrolyte, etc.

Based on the type of electrolyte, fuel cells may be classified into polymer electrolyte membrane fuel cell (PEMFC), phosphoric acid fuel cell (PAFC), direct methanol fuel cell (DMFC), molten carbonate fuel cell (MCFC), solid oxide fuel cell (SOFC), etc.

The polymer electrolyte membrane fuel cell has advantages of high power density, high efficiency, low operation temperature, short starting time, and fast response. Accordingly, the polymer electrolyte membrane fuel cell can be used to provide electric power in small electronic products such as portable devices as well as to provide electric power for automotive and household use. The unit cell includes an electrolyte membrane, electrodes (a fuel electrode and an air electrode), gas diffusion layers (GDLs), separators, gaskets, etc. Such unit cells are stacked to form a fuel cell stack.

A structure in which electrodes are adhered to an electrolyte membrane is called a membrane electrode assembly (MEA). An ion conductive polymer is primarily used as the electrolyte membrane of the membrane electrode assembly, which has properties of excellent ion conductivity, high mechanical strength under a high humidity condition, low gas permeability, high thermal/chemical stability, etc.

The gas diffusion layers minutely diffuse hydrogen and air introduced through separator channels to supply the same to the membrane electrode assembly, support the catalyst layer, move electrons generated from the catalyst layer to the separators, and act as a channel for discharging the generated water outside the catalyst layer. Such gas diffusion layers are stacked on top and bottom surfaces of the membrane electrode assembly.

For convenience in manufacturing the fuel cell stack, it is necessary to assemble the membrane electrode assembly and the gas diffusion layers in an integral body. If the gas diffusion layers and the membrane electrode assembly are not integrally assembled but are merely stacked, the stack structure becomes unstable, and thus the stacking quality may be deteriorated. Typically, the gas diffusion layers and the membrane electrode assembly are simply bonded using a thermal compression bonding method.

Poor stacking quality of the gas diffusion layers and the membrane electrode assembly may deteriorate the performance and durability of the fuel cell. Even worse, a product with poor stacking quality is determined to be defective, and the use and supply thereof is restricted.

Further, when gas inlet and outlet channel gaskets are injection molded to the separators, product defects may occur due to deformation of the separators.

### SUMMARY

It is an object of the present invention to provide a channel frame which is used for fuel cells in order to integrally assemble a membrane electrode assembly (MEA) and gas diffusion layers (GDLs), and includes inlet and outlet channels for reaction gas.

In accordance with the present invention, the above and other objects can be accomplished by the provision of a channel frame for fuel cells for integrally assembling a membrane electrode assembly (MEA) having an electrolyte membrane, an anode electrode and a cathode electrode, and gas diffusion layers (GDLs) disposed on both surfaces of the membrane electrode assembly, the channel frame including at least one protruding portion which protrudes toward an anode-side separator and a cathode-side separator and defines inlet or outlet channels for reaction gas on the channel frame.

The channel frame may be manufactured through extrusion molding, injection molding, or machining

The channel frame may be made of liquid crystalline polymer (LCP), metal, or ceramic material.

A thickness in a vertical direction of the protruding portion may be less than a thickness in the vertical direction of gaskets before compression, the gaskets being located between the channel frame and the anode-side separator and between the channel frame and the cathode-side separator and being subjected to vertical compression to seal gaps between the channel frame and the anode-side separator and between the channel frame and the cathode-side separator.

Alternatively, the thickness in the vertical direction of the protruding portion may be equal to the thickness in the vertical direction of the gaskets after compression.

The channel frame may further include a bonding portion disposed on both lateral surfaces of an integral body, in which the membrane electrode assembly and the gas diffusion layers are stacked, and an extending portion extending outwards from the bonding portion.

The protruding portion may be protrudingly formed on the extending portion.

The protruding portion may be branched into a plurality of protrusions toward the anode-side separator or the cathode-side separator.

A fuel cell according to the present invention includes: a channel frame for integrally assembling a membrane electrode assembly (MEA) having an electrolyte membrane, an anode electrode and a cathode electrode, and gas diffusion layers (GDLs) disposed on both surfaces of the membrane electrode assembly, the channel frame including: at least one protruding portion protruding toward an anode-side separator and a cathode-side separator, where the protruding portion defines inlet or outlet channels for reaction gas on the channel frame.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically illustrating the structure of a channel frame according to an embodiment of the present invention;

FIG. 2 is a view schematically illustrating the interior of a unit cell of a fuel cell including the channel frame according to an embodiment of the present invention;

FIGS. 3A and 3B are plan views of an anode-side structure and a cathode-side structure of a unit cell of a fuel cell including the channel frame having protruding portions according to an embodiment of the present invention; and

FIGS. 4A-4B, 5A-5B, 6A-6B, 7A-7B, 8A-8B, and 9A-9B are views illustrating the interior of a unit cell of a fuel cell including a channel frame according to various embodiments of the present invention, before and after forming a fuel cell stack.

### DETAILED DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” ^{an} _{and} ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Reference will now be made in detail to the preferred embodiments of the present invention, examples of which are illustrated in the accompanying drawings.

Wherever possible, the same reference numbers will be used throughout the drawings to refer to the same or like parts.

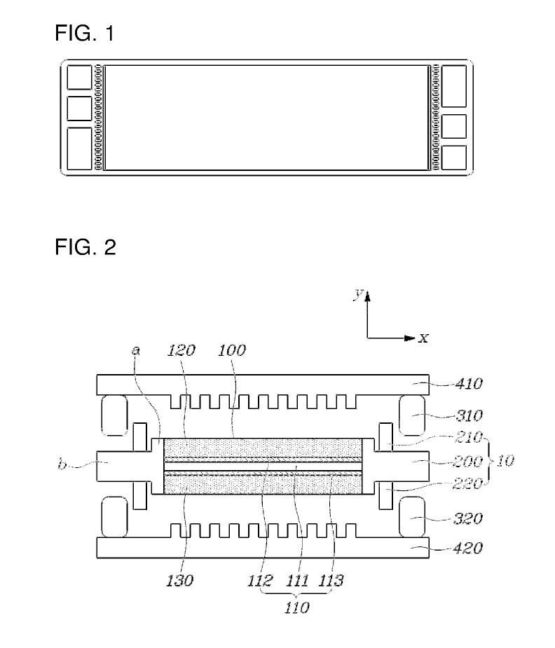

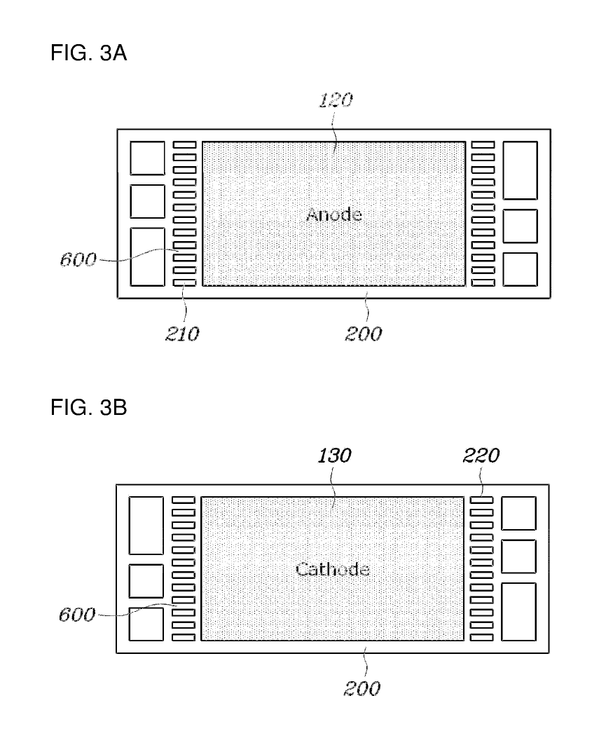

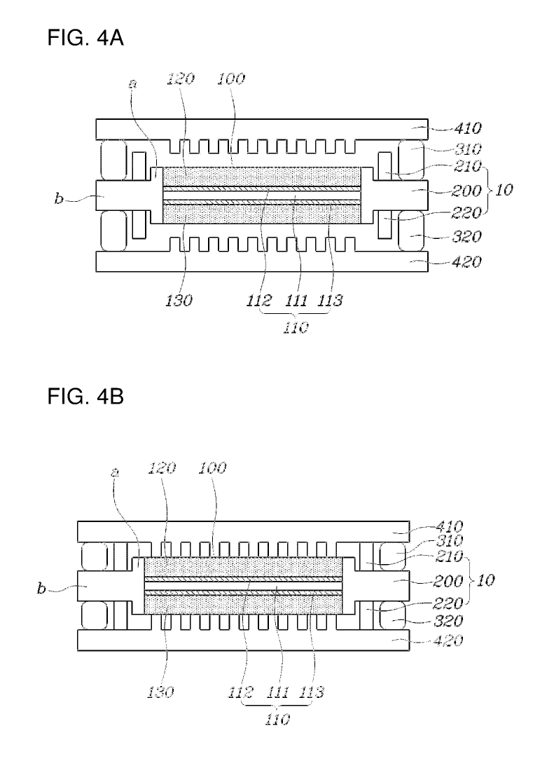

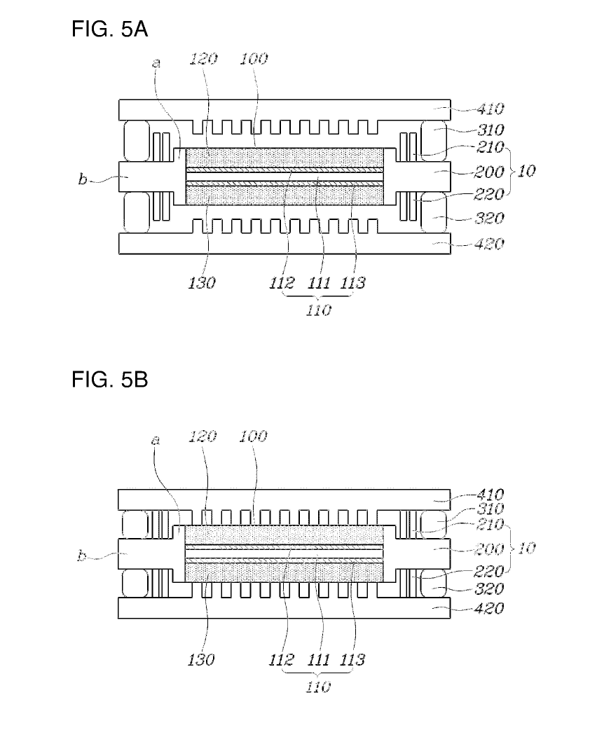

FIG. 1 is a view schematically illustrating the structure of a channel frame according to an embodiment of the present invention. FIG. 2 is a view schematically illustrating the interior of a unit cell of a fuel cell including the channel frame according to an embodiment of the present invention. FIGS. 3A and 3B are plan views of an anode-side structure and a cathode-side structure of a unit cell of a fuel cell including the channel frame having protruding portions according to an embodiment of the present invention. FIGS. 4A-4B, 5A-5B, 6A-6B, 7A-7B, 8A-8B, and 9A-9B are views illustrating the interior of a unit cell of a fuel cell including a channel frame according to various embodiments of the present invention, before and after forming a fuel cell stack (before and after compression).

A channel frame for fuel cells according to an embodiment of the present invention is used for fuel cells in order to integrally assemble a membrane electrode assembly (MEA) 110 having an electrolyte membrane 111, an anode electrode 112 and a cathode electrode 113, and gas diffusion layers (GDLs) 120 and 130 disposed on both surfaces of the membrane electrode assembly 110. The channel frame may include one or more protruding portions 210 and 220, which protrude toward an anode-side separator 410 and a cathode-side separator 420. As used herein, the terms “at least one protruding portion” or “one or more protruding portions” encompass protruding portions (e.g., protruding portions 210, 220), which may have the same or different shapes, and may be referred to as “first” and “second” protruding portions, for example.

The channel frame 10 may be manufactured through extrusion molding, injection molding, or machining, and may be made of a material selected from the group consisting of: liquid crystalline polymer (LCP), metal, ceramic, and combinations thereof.

The thickness in a vertical direction (the thickness in the y-axis direction in the drawings) of the protruding portions 210 and 220 may be less than or equal to the thickness in the vertical direction of gaskets 310 and 320 before compression, the gaskets being located between the channel frame 10 and the anode-side separator 410, and between the channel frame 10 and the cathode-side separator 420, and being subjected to vertical compression to seal gaps between the anode-side and cathode-side separators 410 and 420 and the channel frame 10.

Also, the thickness in the vertical direction of the protruding portions 210 and 220 may be equal to the thickness in the vertical direction of the gaskets 310 and 320 after compression, the gaskets being located between the channel frame 10 and the anode-side separator 410, and between the channel frame 10 and the cathode-side separator 420, and being subjected to vertical compression to seal gaps between the anode-side and cathode-side separators 410 and 420 and the channel frame 10.

That is, depending on the thickness in the vertical direction of the protruding portions 210 and 220, the compressive force applied to the gaskets 310 and 320 when the fuel cell stack is manufactured may be adjusted. Therefore, when the fuel cell stack is formed, the gaskets may be prevented from being excessively compressed due to compressive load. When the compressive load is applied, the distance between the anode-side separator 410 and the cathode-side separator 420 depends on the thickness in the vertical direction of the protruding portions 210 and 220, and accordingly the thickness of the gaskets 310 and 320 also depends on the thickness in the vertical direction of the protruding portions 210 and 220. As a result, the compressive force that is to be applied to the gaskets 310 and 320 may be changed depending on the thickness of the protruding portions 210 and 220, so that the thickness in the vertical direction of the protruding portions 210 and 220 and the thickness in the vertical direction of the gaskets 310 and 320 become the same.

The protruding portions 210 and 220 include at least one first protruding portion 210 which protrudes toward the anode-side separator 410 and at least one second protruding portion 220 which protrudes toward the cathode-side separator 420. The first protruding portion 210 and the second protruding portion 220 may have the same shape, and may be provided in plural numbers.

The channel frame 10 may include a bonding portion a which is disposed on both lateral surfaces of an integral body 100, in which the membrane electrode assembly 110 and the gas diffusion layers 120 and 130 are stacked, and an extending portion b which extends outwards from the bonding portion a. The protruding portions 210 and 220 may be protrudingly formed on the extending portion b.

The channel frame 10 serves to securely support the boundary of the membrane electrode assembly 110 and the gas diffusion layers 120 and 130 so that they are integrally assembled. The thickness in the vertical direction of the channel frame 10 may be decreased toward the outer edge of the channel frame 10. That is, the thickness may be decreased toward the extending portion b from the bonding portion a.

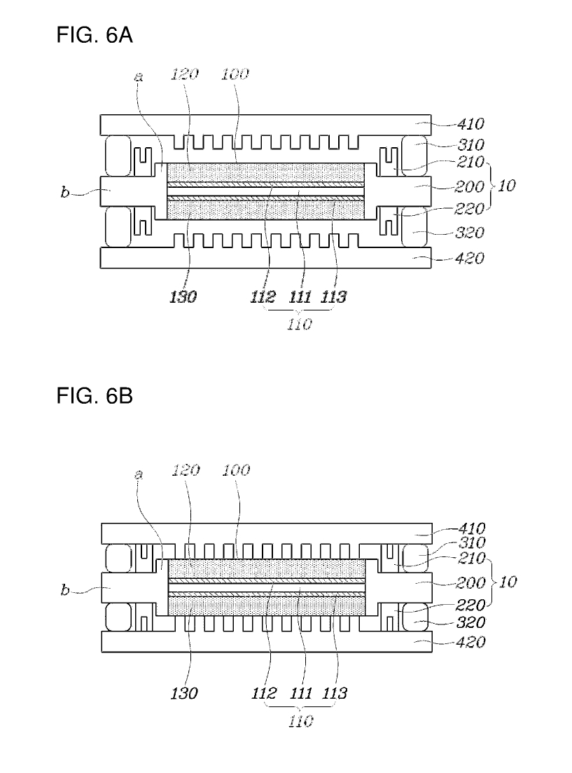

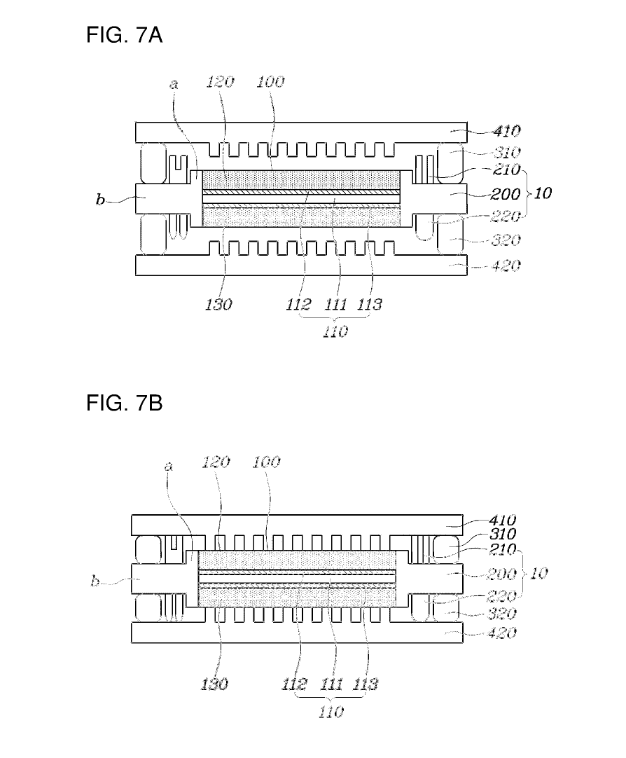

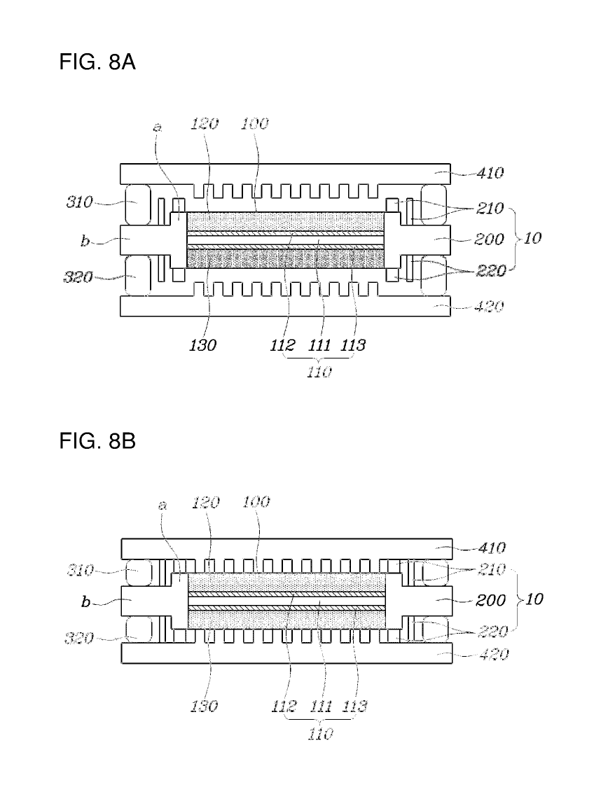

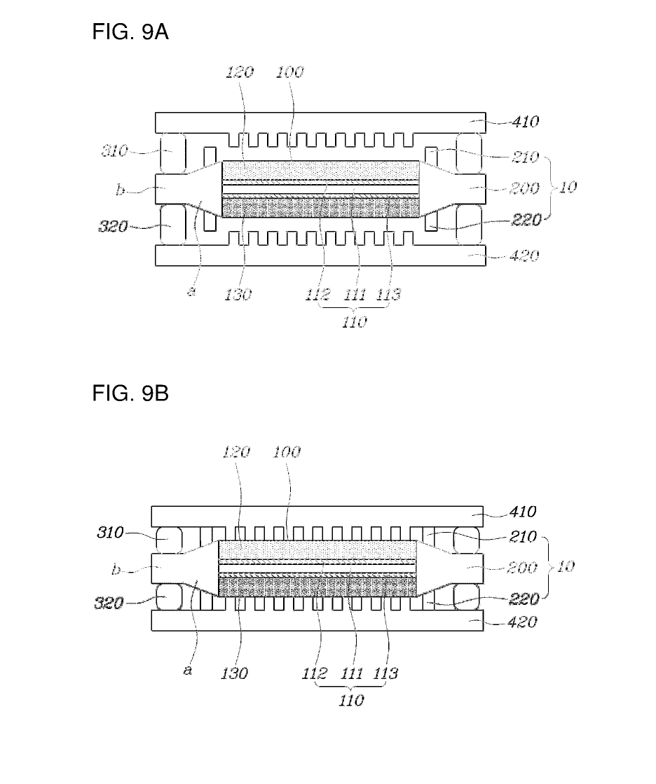

As shown in FIGS. 6A and 6B, the protruding portions 210 and 220 may be branched into a plurality of protrusions toward the anode-side separator 410 or the cathode-side separator 420. Accordingly, the structural stability of flow channels 600 may be increased. FIGS. 7A, 7B, 8A, 8B, 9A and 9B illustrate various examples of the shape of the protruding portions 210 and 220. Referring to FIGS. 7A and 7B, the protruding portions 210 and 220 may be divided into two parts having a rectangular section to additionally create a flow channel therebetween, or may be formed in a single part having a convexly curved end portion. Referring to FIGS. 8A and 8B, the protruding portions 210 and 220 may be additionally formed on the bonding portion a, thereby more stably supporting the bonding portion a. Referring to FIGS. 9A and 9B, a junction portion between the bonding portion a and the extending portion b, which extends outwards from the bonding portion a, may be formed so as to have a relatively gentle slope, and the protruding portions 210 and 220 may be formed on the slope.

In conclusion, the protruding portions 210 and 220 define the inlet and outlet channels 600 for reaction gas of the fuel cell. Further, the airtightness and durability of the fuel cell may be further enhanced.

As is apparent from the above description, since an injection molding process is performed when the membrane electrode assembly (MEA) and the gas diffusion layers (GDLs) are integrally assembled, the assembly and handling efficiency thereof are increased, and the defective fraction of the membrane electrode assembly is remarkably decreased. Accordingly, manufacturing costs may be reduced, integral assembling efficiency may be increased, and the product defect rate may be reduced.

Further, deformation of the separators, which may be caused when the gaskets for reaction gas inlet and outlet channels are made through injection molding, may be prevented, and the quality and manufacturing efficiency of the integral assembly of the separators and the gaskets may be enhanced.

Further, the channel frame having the reaction gas channels may prevent excessive compression of the gaskets, which may be caused by compressive load when the fuel cell stack is formed.

Further, the assembling efficiency, airtightness and durability of the fuel cell stack may be enhanced.

Furthermore, since fuel cell manufacturing processes are reduced, production lines may be simplified, and productivity may be improved.

In addition, as the injection molding process is automated and precisely performed, the product defect rate may be reduced, and mass production may be realized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A channel frame for fuel cells for integrally assembling a membrane electrode assembly (MEA) having an electrolyte membrane, an anode electrode and a cathode electrode, and gas diffusion layers (GDLs) disposed on both surfaces of the membrane electrode assembly, the channel frame comprising:
at least one protruding portion protruding toward an anode-side separator and a cathode-side separator,
wherein the protruding portion defines inlet or outlet channels for reaction gas on the channel frame.

2. The channel frame according to claim 1, wherein the channel frame is manufactured through extrusion molding, injection molding, or machining.

3. The channel frame according to claim 1, wherein the channel frame is made of liquid crystalline polymer (LCP), metal, or ceramic material.

4. The channel frame according to claim 1, wherein a thickness in a vertical direction of the protruding portion is thinner than a thickness in the vertical direction of gaskets before compression for manufacturing of fuel cell stack, the gaskets being located between the channel frame and the anode-side separator and between the channel frame and the cathode-side separator, and being subjected to vertical compression to seal gaps between the channel frame and the anode-side separator and between the channel frame and the cathode-side separator.

5. The channel frame according to claim 1, wherein a thickness in a vertical direction of the protruding portion is equal to a thickness in the vertical direction of gaskets after compression for manufacturing of fuel cell stack, the gaskets being located between the channel frame and the anode-side separator and between the channel frame and the cathode-side separator, and being subjected to vertical compression to seal gaps between the channel frame and the anode-side separator and between the channel frame and the cathode-side separator.

6. The channel frame according to claim 1, further comprising:
a bonding portion disposed on both lateral surfaces of an integral body, in which the membrane electrode assembly and the gas diffusion layers are stacked; and
an extending portion extending outwards from the bonding portion.

7. The channel frame according to claim 6, wherein the protruding portion is protrudingly formed on the extending portion.

8. The channel frame according to claim 1, wherein the protruding portion is branched into a plurality of protrusions toward the anode-side separator or the cathode-side separator.

9. The channel frame according to claim 1, wherein the protruding portion includes a first protruding portion located near the anode electrode and a second protruding portion located near the cathode electrode, the first and second protruding portions having different shapes.

10. The channel frame according to claim 1, wherein a first protruding portion located in the inlet of reactant gas and a second protruding portion located in the outlet of reactant gas have different shapes.

11. A fuel cell, comprising:
a channel frame for integrally assembling a membrane electrode assembly having an electrolyte membrane, an anode electrode and a cathode electrode, and gas diffusion layers disposed on both surfaces of the membrane electrode assembly, the channel frame comprising:
at least one protruding portion protruding toward an anode-side separator and a cathode-side separator,
wherein the protruding portion defines inlet or outlet channels for reaction gas on the channel frame.
